(19) United States
(12) Patent Application Publication
(10) Pub. No.: US 2011/0157030 A1
(43) Pub. Date: Jun. 30, 2011

(54) Methods and Systems for Data Serialization

(75) Inventor: Lin Xu, Shanghai (CN)

(73) Assignee: AMLOGIC CO., LTD., Santa Clara, CA (US)

(21) Appl. No.: 12/651,411

(22) Filed: Dec. 31, 2009

(51) Int. Cl. G06F 3/041

(52) U.S. Cl. 345/173

(57) ABSTRACT

A method for detecting one or more objects on a touch screen, wherein the touch screen has a plurality of transmitters and receivers, comprises the following steps: serializing data signals into a group data signal corresponding to the transmitters and the receivers of the touch screen; transmitting and deserializing the group data signal to the transmitters and the receivers; receiving receiver data indicative of the detection of one or more objects on the touch screen; serializing the receiver data into serialized common data signal; and outputting the common data signal, wherein the common data signal is indicative of the detected objects on the touch screen.

### FIELD OF INVENTION

This invention generally relates to methods and systems for data serialization, and, more particularly, to methods and systems for data serialization using shift registers to operate transmitters and receivers of an optical touch screen.

### BACKGROUND

Touch sensors can be used in conjunction with a variety of display devices, including cathode ray tubes (“CRTs”) and liquid crystal displays (“LCDs”), as a means of inputting information into a data processing system. For instance, a mouse pad of a notebook computer can be used to guide a pointer on a display device and select an icon or element displayed on the display device. Furthermore, a touch screen can be placed over a display or integrated into the display such that a user can select a displayed icon or element by touching the screen in a location corresponding to the selected icon or element.

Touch screens have become common place in a variety of different applications including, for example, point-of-sale applications such as cash registers at fast-food restaurants, point-of-information applications such as department store information kiosks, ticketing applications such as airline-ticket kiosks, and other applications.

An optical type touch screen can have a detection grid for detecting an object, which is generated by paired light transmitters and light receivers that surround the display of the touch screen. The paired light transmitters and receivers form a grid of crossed light beams along an x-axis and a y-axis of the touch screen. The beams can be sequentially activated to determine if any beams are blocked by an object. If a blocked beam is detected during this scanning operation, then that information can be used to determine the x-axis and the y-axis location for the blocking object.

FIG. 1 illustrates a conventional structure for an optical touch screen. A touch screen has a detection area 100, where the detection area 100 is covered by a lattice of light beams emitted from transmitters 104 and 108 to receivers 106 and 110. The receivers 106 and 110 are positioned along the side of the detection area 100 to correspond to the respective transmitters 104 and 108; thus the transmitters and the receivers are paired to one another. The transmitters 104 and 108 emit beams in the direction toward their paired receivers 106 and 110 such that the emitted beams form the lattice.

If a receiver does not detect the light beam from its paired transmitter, then a touch event is triggered. For instance, if the user puts an object 102 (e.g., the user's finger, a stylus, or other object), on the detection area 100, then some beams are intercepted (e.g., absorbed, reflected, refracted, etc.) by the object 102. The result is that the beams that were intercepted by the object 102 are not detected by the corresponding receivers 106 and 110. The touch screen determines the x-axis location and the y-axis location of the object 102 based on the receivers that did not detect their paired light.

FIG. 2 illustrates a block diagram for operating multiple receivers and transmitters for a touch screen. Generally, each transmitter and each receiver are connected to a general input and output (“GPIO”) line of an integrated circuit (“IC”) on the system side 202 via an application driving circuit. Therefore, the total number of GPIO pins of the IC can vary depending on the number of transmitters and receivers of the touch screen. The greater the number of transmitter and receivers, the greater the number of GPIO pins is needed to control the transmitters and receivers.

Designing a system to accommodate a variable number of GPIO pins often requires adding more GPIO pins to at least support a maximum number of transmitters and receivers. Considerable costs can be added to the manufacture of the system with the addition of each GPIO pin to the IC. Also, additional pins and/or larger package sizes often create greater physical challenges in attaching an IC to a circuit board, whether through direct soldering or through a socket, which can also increase costs.

Therefore, it is desirable to find ways to design such ICs for having a predefined number of GPIO pins for operating a potentially variable number of transmitters and receivers of a touch screen. In particular and in one aspect, it is desirable to find ways to design ICs to use serial-parallel shift (“SPS”) registers and parallel-serial shift (“PSS”) registers to serialize and deserialize data for transmitters and receivers of a touch screen.

### SUMMARY OF INVENTION

An object of this invention is to provide methods for managing transmitter and receiver pairs of a touch screen by a serialized data input and a serialized data output scheme.

Another object of this invention is to provide methods for operating transmitter and receiver pairs of a touch screen without having to provide a GPIO line to manage each transmitter and each receiver.

Yet another object of this invention is to provide systems for a touch screen, where the number of resources spent on interconnecting the GPIO pins of the system with the transmitters and receivers are minimized.

Briefly, a method for detecting one or more objects on a touch screen, wherein the touch screen has a plurality of transmitters and receivers, comprises the following steps: serializing data signals into a group data signal corresponding to the transmitters and the receivers of the touch screen; transmitting and deserializing the group data signal to the transmitters and the receivers; receiving receiver data indicative of the detection of one or more objects on the touch screen; serializing the receiver data into serialized common data signal; and outputting the common data signal, wherein the common data signal is indicative of the detected objects on the touch screen.

An advantage of this invention is that methods are provided for managing transmitter and receiver pairs of a touch screen by a serialized data input and a serialized output scheme using shift registers.

Another advantage of this invention is that methods are provided for operating transmitter and receiver pairs of a touch screen without having to provide a GPIO line to manage each transmitter and each receiver.

Yet another advantage of this invention is that systems are provided for a touch screen, where the number of resources spent on interconnecting the GPIO pins of the system with the transmitters and receivers are minimized.

### DESCRIPTION OF THE DRAWINGS

The foregoing and other objects, aspects, and advantages of the invention will be better understood from the following detailed description of the preferred embodiment of the invention when taken in conjunction with the accompanying drawings in which:

FIG. 1 illustrates a conventional structure for an optical touch screen.

FIG. 2 illustrates a block diagram for operating multiple receivers and transmitters for a touch screen.

FIG. 3 illustrates a block diagram for serializing signals for operating transmitters and receivers of a touch screen.

FIG. 4 illustrates a data transmission module of the present invention.

FIG. 5 illustrates a programmable power supply module of the present invention.

FIG. 6 illustrates a block diagram for a receiver module of the present invention.

FIGS. 7a-7b illustrate a receiver block of the present invention.

FIG. 8 illustrates a transmitter module of the present invention.

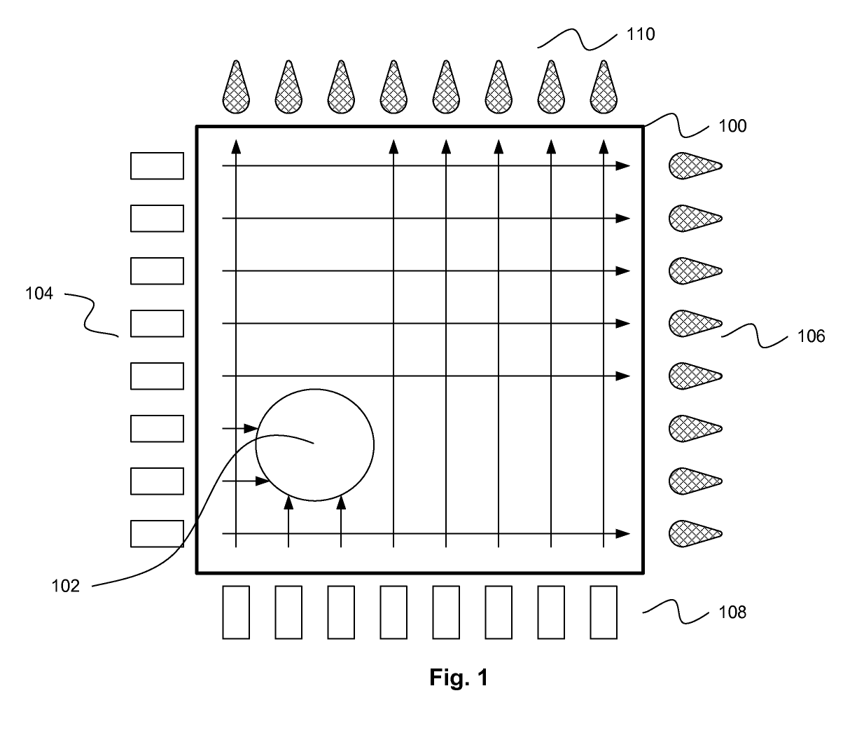

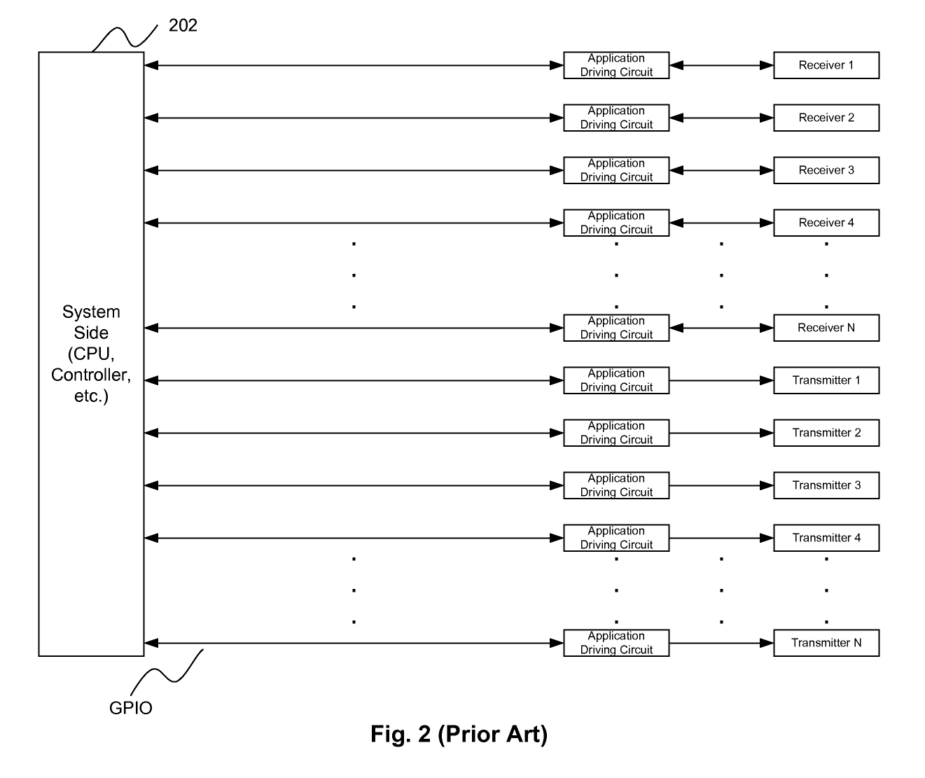

### DETAILED DESCRIPTION OF THE PREFERRED EMBODIMENTS

The present invention can be described with respect to serializing and deserializing signals for operating transmitters and receivers of a touch screen. However, it is to be understood that the present invention can be applied to other systems, apparatuses, and components, where serialized data transmission can be used for parallel operation of multiple devices.

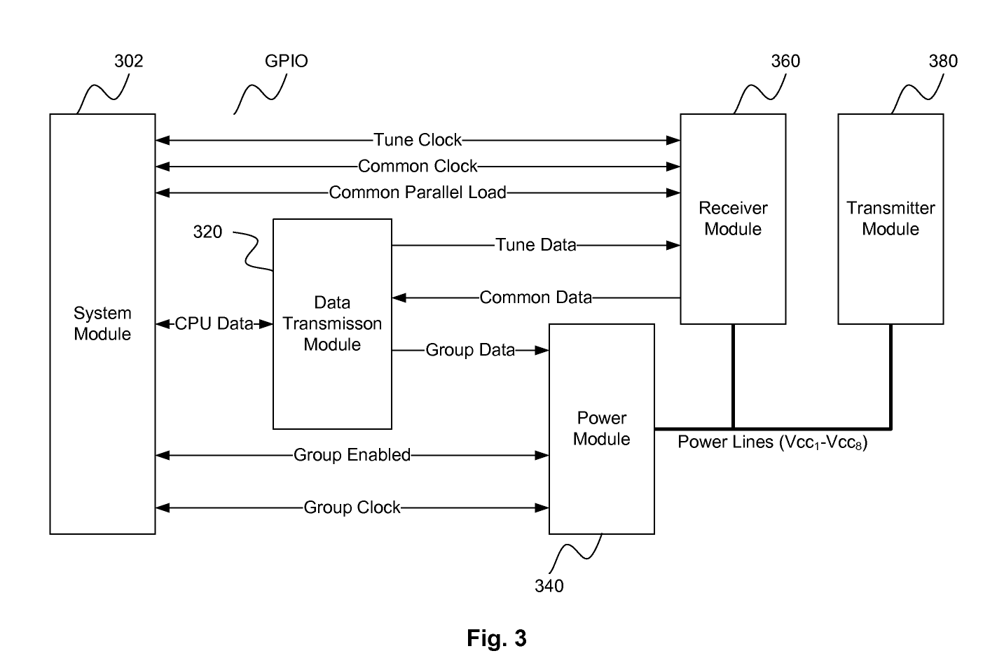

FIG. 3 illustrates a block diagram for serializing signals for operating transmitters and receivers of a touch screen. A system module 302 can comprise a central processing unit (“CPU”), microcontroller, and/or other integrated circuits for operating a data transmission module 320, a power module 340, a receiver module 360, and a transmitter module 380. The system module 302 can have GPIO pins to serve as input lines and output lines for data transmission between the other modules 320, 340, 360, and 380 and the system module 302. These pins can be referred to as a tune clock pin, a common clock pin, a common parallel load pin, a CPU data pin, a group enabled pin, and a group clock pin.

The system module 302 serializes multiple control signals to operate the power module 340, the receiver module 360, and the transmitter module 380. The serialized control signals can be transmitted through the CPU data pin to the data transmission module 320. The data transmission module 380 further relays the serialized control signals to the receiver module 360 and the power module 340. Additionally, a serialized data stream carrying receiver data can be transmitted from the receiver module 360 to the system module 320 via the CPU data pin.

With respect to deserializing the serialized control signal for the power module 340, the serialized data from the transmission module 320 is entered into a serial to parallel shift register for parallel output. Shift registers are components which are used in data processing, and serve to delay digital signals or to distribute them among various channels. Shift registers comprise a number of stores which are interconnected in such a manner that the data contained therein can be stepped from one store to the next succeeding store in response to an initiating control signal, the result being that a new piece of data is delivered to the first store and a piece of data is delivered up by the last store. During each group clock cycle, the shift register takes the group data and clocks it to its next buffer and passes all the values from the group data signal to a parallel output.

Thus, the quantity of GPIO pins on the system module that must be directly supported by bus logic to transmit signals to and receive signals from the transmitters and receivers is minimized. For example, fewer GPIO output pins are needed since serializing the states to be driven onto the output signal lines and serially transmitting those states to one or more shift registers having parallel outputs to drive output signal lines reduces the number of GPIO pins needed. Furthermore, fewer GPIO input pins are needed since parallel inputs to one or more other external shift registers are serialized and serially transmitted to the bus logic.

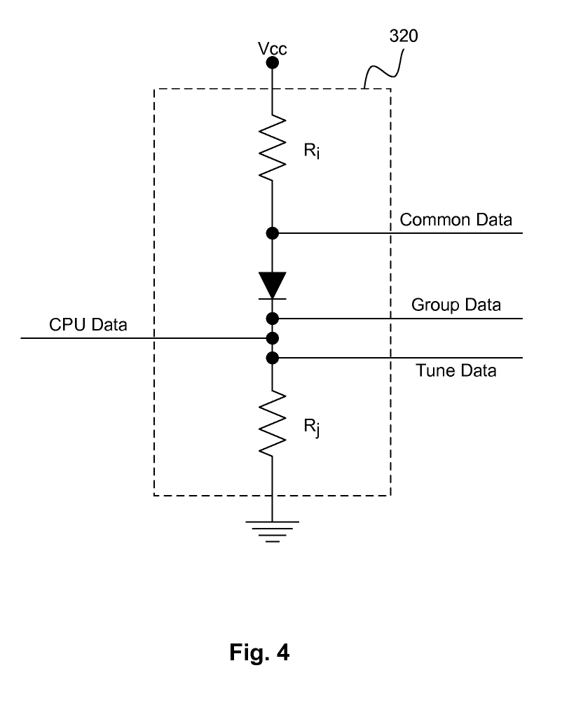

FIG. 4 illustrates a data transmission module of the present invention. In order to further minimize the number of GPIO pins of the system side 302, the CPU data signal can be split into three different signal flows to other modules by the data transmission module 320. For instance, in a first signal flow, the data transmission module 302 can transmit a CPU data signal to the receiver module 360 (wherein this signal can be referred to as a “tune data” signal). Next, after the tune data signal, a second signal flow can begin to the power module (wherein this signal can be referred to as a “group data” signal). Finally, a third signal flow can be started, wherein the data from the receivers is applied on the CPU data signal from the receiver module 360 (wherein this signal can be referred to as a “common data” signal). In essence, the tune data signal, the group data signal, and the common data signal represent the CPU data signal at different times. It is important to note that the signal flow can be in any order, and is not limited to the example given above.

Since a single signal flow is operated at any one time according to a clock signal, a single GPIO pin can be used to operate multiple modules and receive data from multiple modules. For instance, the CPU data signal may not be transmitting controls signals to the transmission module 320, but can receive a data stream that is transmitted to the system module 302.

The data transmission module 320 can have a voltage V_{CC} applied on a terminal of a resistor Rᵢ. The other terminal of the resistor Rᵢ is connected to a terminal of a diode, where the common data signal is applied at this connection. The other terminal of the diode is connected to a node where the CPU data signal, the group data signal, and the tune data signal are applied. The other terminal of the diode is connected to ground via a resistor Rⱼ.

Note, the input signal flow and output signal flows of the transmission module 320 might be confused even when operated at different times. For instance, if common data signal is logically low, it will not affect tune data signal and group data signal since the diode will isolate a logic low state. However, if the last status of the common data signal is logic high, then a current may travel through the diode and affect the output of the other data signals. Therefore, it must be guaranteed that the logical data of the common data signal of the last status is low. One method can be to hardwire the common data signal flow to ground.

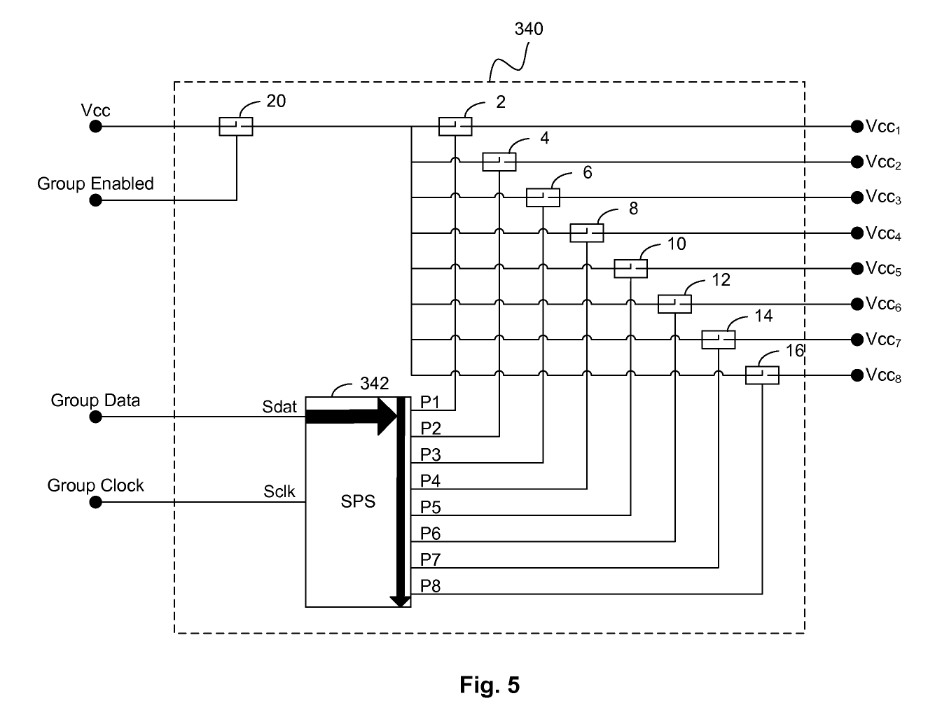

FIG. 5 illustrates a programmable power supply module of the present invention. The group data signal is applied to a Sdat input of a SPS register 342 for deserializing the serialized data from the group data signal for parallel output. The parallel outputs of the SPS register 342 can be denoted P1-P8. During each cycle of the group clock signal (which is applied to the Sclk input of the SPS register 342), the group data signal is sampled for a value and buffered in the SPS register 342. The previously buffered values are shifted from one buffered position to the next buffered position, and outputted in parallel by the SPS register 342.

For instance, during each group clock cycle the buffered value for P7 is shifted and buffered for P8, the buffered value for P6 is shifted and buffered for P7, the buffered value for P5 is shifted and buffered for P6, and so on and so forth. The value sampled from the group data signal is buffered for P1. Finally, the values P1-P8 are outputted in parallel to control the eight sub-power supplies VCC₁, VCC₂, VCC₃, VCC₄, VCC₅, VCC₆, VCC₇, and VCC₈.

The transmitters and receivers pairs can be activated and deactivated by driving switches 2, 4, 6, 8, 10, 12, 14, and 16, which supply VCC to corresponding sub-power supplies of the transmitters and receivers. The outputs P1-P8 of the SPS register 342 control whether the switches are opened (which deactivates the corresponding one or more pairs of transmitters and receivers for that switch) or closed (which activates the corresponding one or more pairs of transmitters and receivers for that switch).

Generally, a scanning scheme is employed to determine which pairs of transmitters and receivers are activated and which pairs of transmitters and receivers are deactivated. The parallel outputs P1-P8 of the SPS register 342 can be programmed according to the scanning order of the scanning scheme. Furthermore, a main switch 20 driven by a group enabled signal can be used disable all power groups, including the selected one, thus all receivers and transmitters are powered off and deactivated. For stability of the circuitry, the correct sequence can be the following. First, during system initialization (or any other cases where the IR touch screen functionality is not needed for a time being), this pin can be disabled to power off all power groups, no matter if certain groups are selected or not. Second, in the normal working mode, when each time a new power group is selected, this pin can be disabled to power off all power groups, no matter if they are selected or not. When a new power group is selected, this pin can be enabled once again to power on the newly selected power group.

Furthermore, each sub-power can activate one or more corresponding transmitter and receiver pairs according to a group scanning scheme. A group scanning scheme is taught in the U.S. utility patent application Ser. No. 12/621,491, entitled “Infrared Touch Screen” and filed on Nov. 18, 2009, which is incorporated here in its entirety.

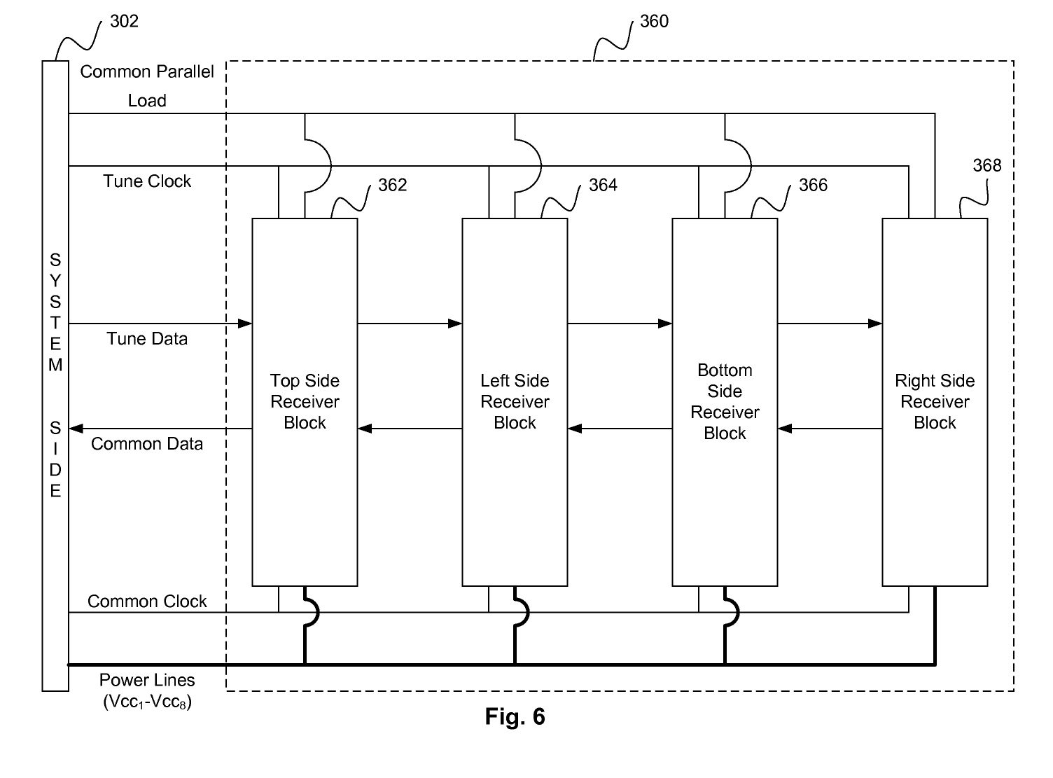

FIG. 6 illustrates a block diagram for a receiver module of the present invention. A receiver module can comprise one or more receiver blocks. A receiver block 362 comprises receivers on a first side of the touch screen; a receiver block 364 comprises receivers on a second side of the touch screen; a receiver block 366 comprises receivers on a third side of the touch screen; and a receiver block 368 comprises receivers on a fourth side of the touch screen.

The number of receiver blocks can vary depending on the design of the touch screen, however, notice that the tune data signal travels from one receiver block to another receiver block, then to another receiver block, and so on until the last receiver block is reached. Similarly, the common data signal is generated at one receiver block, then travels to the next receiver block, and so on until the common data signal is received on the system side 302.

With respect to the tune data signal, the tune data signal is used to tune the individual receivers to specified sensitivity levels. Instead of having separate GPIO pins to tune each receiver, the tune data signal can be a single serialized data signal wherein the tuning data for each receiver can be set at a certain point along that signal. For instance, the tune data signal can be sampled once every tune clock cycle, where each tune clock cycle can correspond to a tuning level for a receiver.

The system side 302 transmits the tune data signal, which is applied to the receiver block 362. The receiver block 362 in turn can pass the tune data signal to the next receiver block 364, until the tune data signal has reached the last receiver block 368.

With respect to the common data signal, the common data signal is a serialized data signal having data detected by the receivers. Similarly to the serialized tune data, the common data signal is transferred from a receiver block to another receiver block until the serialized data signal is received at the system side 302.

The common data signal comprises data received by the receivers. Instead of having separate GPIO pins to read data received by each receiver, the common data signal can be a single serialized data signal wherein the data received for each receiver can be read at a certain point along that signal. For instance, the common data signal can be sampled once every common clock cycle, where each common clock cycle can correspond to data for one of the receivers.

The receiver block 368 can initiate the common data signal, which is applied to the receiver block 366. The receiver block 366 can include its receiver data to the common data signal, and then transmit the common data signal to the next receiver block 364, until the common data signal reaches the system side 302.

The receiver blocks can represent receivers positioned along one or more sides of the touch screen. For instance, the receiver block 362 can comprise receivers positioned along a top side of the touch screen; the receiver block 364 can comprise receivers positioned along a left side of the touch screen; the receiver block 366 can comprise receivers positioned along a bottom side of the touch screen; and the receiver block 368 can comprise receivers positioned along a right side of the touch screen.

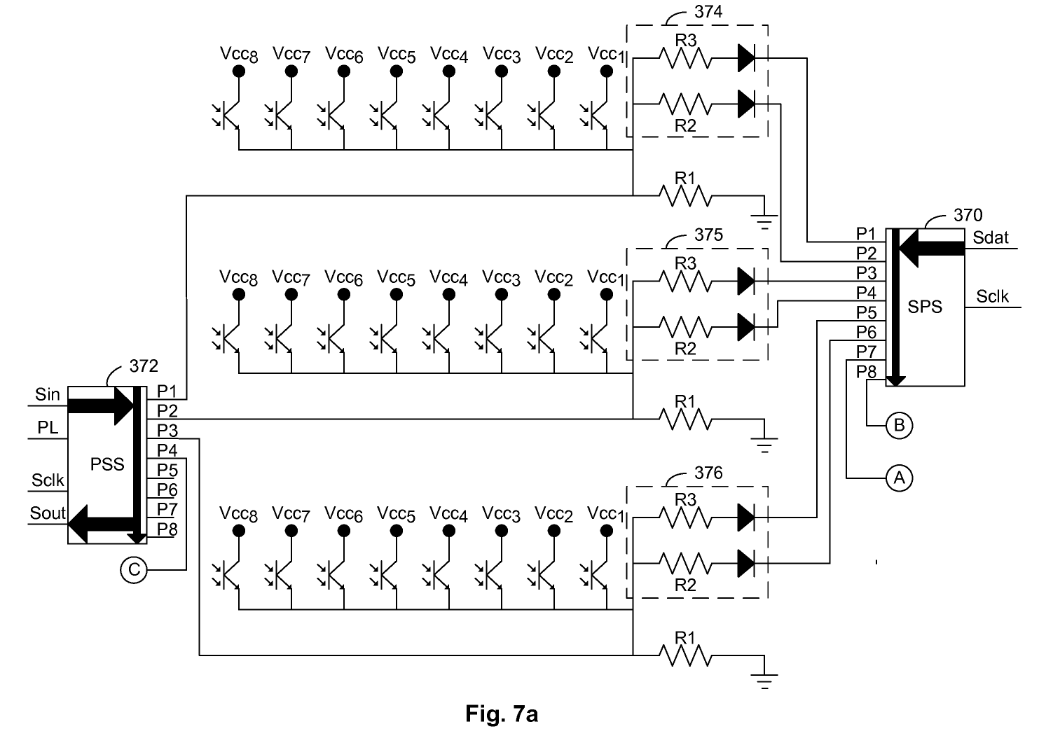

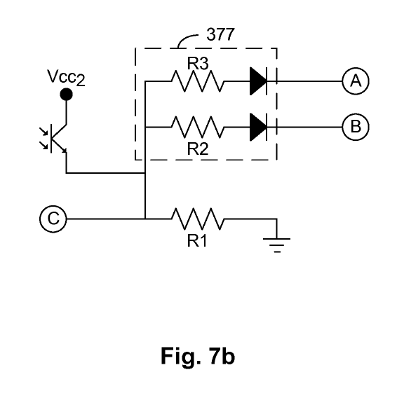

FIGS. 7a-7b illustrate a receiver block of the present invention. A receiver block may comprise a plurality of receivers driven by the sub-power supplies VCC₁, VCC₂, VCC₃, VCC₄, VCC₅, VCC₆, VCC₇, and VCC₈, tuning circuits 374-377, a SPS register 370 for controlling the tuning circuits, and a PSS register 372 for serializing the data received by the receivers. The receivers can be clustered into several groups, where each receiver in the group is activated by a different sub-power supply. Only one receiver within a single group may be activated at any given moment according to the grouping scanning scheme.

Each group of receivers can have a tuning circuit (e.g., tuning circuit 374-377) to adjust the sensitivity of the active receiver for that group. The tuning circuits 374-377 can be controlled by one or more outputs of the SPS register 370. The SPS register 370 can receive the tune data signal for parallel output to the tuning circuits 374-377. Since the SPS register 370 can have multiple outputs for outputting the tuning signal, there can be multiple tuning circuits that can be controlled by the tune data signal. Furthermore, multiple SPS registers can be daisy chained together such that the number of tuning circuits to be controlled by the tune data signal is not confined to the number of outputs of any single SPS register. The SPS registers can be daisy chained by outputting the last output of a SPS register to the Sdat input of the next SPS register, which can be repeated until the tune data signal is passed to the various SPS registers.

Generally, a receiver is a photodiode (or other receiver device), which can generate electrical current based on the strength of the light detected by the photodiode. The generated current is then applied across a resistor to determine a voltage. Thus, the stronger the light detected, the larger the current, and thus subsequently the larger the voltage for a given resistance.

In an embodiment of the present invention, a tuning circuit can adjust the effective resistance to which the current is applied, thus adjusting the detected voltage. After days or months, the electrical properties of the receivers and the ambient conditions change such that the beams of light detected by the receivers may be weaker or stronger than at previous times. For instance, if the touch screen is near an external light source (e.g., sun light) then the touch screen may add that external light to the detection of the transmitted light from the transmitters of the touch screen. It may be necessary to adjust the sensitivity level because the receivers may erroneously detect a light reading due to the ambient light and non-ideal characteristics of the receiver. Ultimately, the receiver may read the ambient light as a light detection thus not registering the blocked object.

During initialization, it can be assumed that an object is not positioned on the touch screen. Thus, all the light beams emitted from the transmitters to the receivers should be detected and all receivers should not detect any beams when all transmitters are off. Upon detection, the measured data from the receivers can be used to calculate the appropriate sensitivity level for each receiver. A suitable resistance is determined for use in the respective tuning circuit for a receiver to ensure the detection of the light beams from its according transmitter and also to avoid erroneous detection of any other external light and other external parameters. This information is saved on the system side for future use when the receivers are activated.

Generally, a pull down resister R1 can be used to convert the current generated by the receiver to a voltage. If a strong light beam is detected by the receiver, then a strong current is generated. The resistor R1 will convert the current to a high voltage. Additionally, if the light beam is initially weak, the receiver generates a small current. Thus, a higher resistance can be needed to generate a higher voltage to be read at the input. Since the digitalized value is of concern, it is determined whether the input is high or low. The threshold for a high value can be when the voltage read is 2.8 V or greater.

If the other resistors in the tuning circuit are enabled, then the resistors R1, R2, and R3 are in parallel making the effective resistance smaller than the resistance R1. Thus, when a strong beam is detected, the total effective resistance is smaller. Therefore, depending on the initial conditions of the voltage level for a high input or a low input, the threshold can be varied by enabling one or more of the other resistors in the tuning circuit.

Each resistor of the tuning circuit is connected to a diode, where the diode is further connected to an output of the SPS register. When the output is high, then the resistor is disabled since the diode is reversed biased; and when the output is low, then the resistor is enabled since the diode can be forward biased.

In all, there can be four levels for adjusting the sensitivity of a receiver. The sensitivity levels correspond to the number of different permutations of the resistors in the tuning circuit that can be enabled and disabled. For instance, the tuning circuit can have two resistors R2 and R3, which can either be enabled or disabled depending on the desired sensitivity level of the receiver. Although, only four levels are implemented in this example, it can be appreciated that any number of levels can be instituted for adjusting the sensitivity level of the resistors since the tuning circuit can have any number of resistors.

Referring back to FIGS. 7a-7b, the output P1 of the SPS register 370 connects to R3 and the output P2 of the SPS register 370 connects to R2. If P1 and P2 of the SPS register 370 are high, then R3 and R2 will not have current applied across these resistors, meaning that the voltage is floating. The current will go through R1 and the other resistors R2 and R3 are floating. The voltage can be determined by multiplying the generated current by the resistance of resistor R1. This voltage will represent the strength of the beam of light that is detected at the receiver. That voltage information is digitalized and positioned read at an input of the PSS register 372. The other activated receivers can also be read at the other inputs P2-P8 of the PSS register 372. These voltage values are serialized to form the common data signal and inputted to the next PSS register in a daisy chained configuration so that all the data from the activated receivers are serialized into the common data signal and inputted back to the system side 302.

In addition, the common parallel load input is applied to the PL input of the PSS register 372. Once the PL input of the PSS register 372 is trigged, all statuses on the parallel input pins are read into the internal buffer of the PSS register 372. Then, during the serialized transmission, the statuses on those parallel pins will not affect the transmitted data. Thus, the common parallel load signal is a sampling clock for sampling the parallel pins' statuses at the same time.

Once the receivers are set to the appropriate sensitivity level, the receivers can be activated for detection. If one of the activated receivers detects an event, then that data can be read at an input of a PSS register. The PSS register can read multiple data in parallel and serialize that data to generate the common data signal.

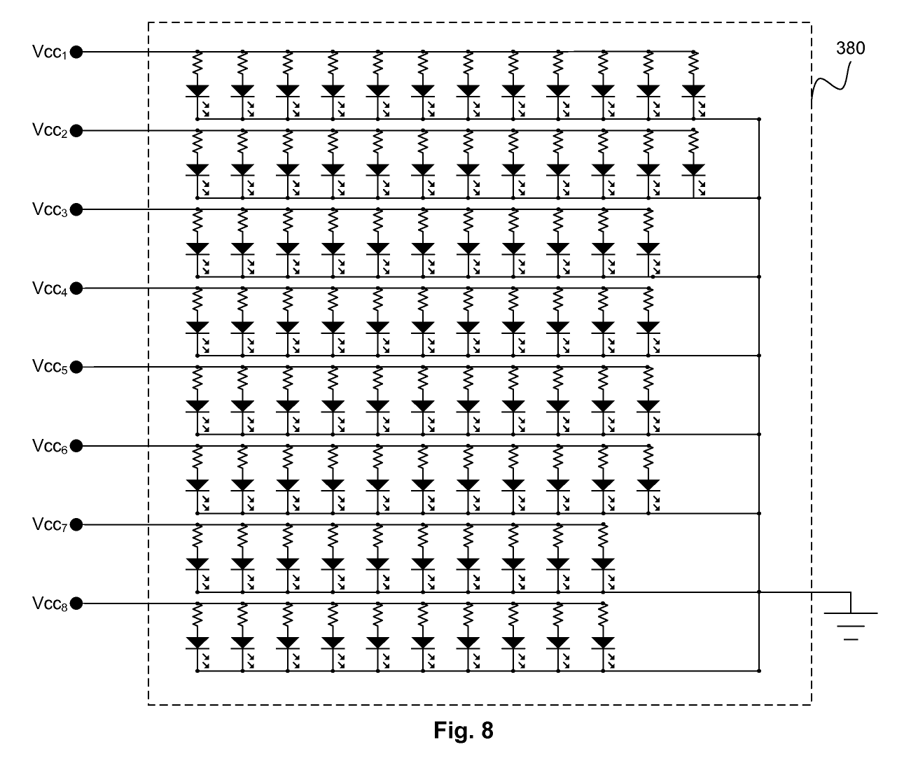

FIG. 8 illustrates a transmitter module of the present invention. A transmitter module can have transmitters grouped such that activation of one or more of the sub-power supplies VCC₁, VCC₂, VCC₃, VCC₄, VCC₅, VCC₆, VCC₇, and VCC₈ can activate the respective transmitters and receivers connected to the sub-power supplies.

While the present invention has been described with reference to certain preferred embodiments or methods, it is to be understood that the present invention is not limited to such specific embodiments or methods. Rather, it is the inventor's contention that the invention be understood and construed in its broadest meaning as reflected by the following claims. Thus, these claims are to be understood as incorporating not only the preferred methods described herein but all those other and further alterations and modifications as would be apparent to those of ordinary skilled in the art.

We Claim:

1. A method for detecting one or more objects on a touch screen, wherein said touch screen has a plurality of transmitters and receivers, comprising the steps:
serializing data signals into a group data signal corresponding to the transmitters and the receivers of the touch screen;
transmitting and deserializing the group data signal to the transmitters and the receivers;
receiving receiver data indicative of the detection of one or more objects on the touch screen;
serializing the receiver data into serialized common data signal; and
outputting the common data signal, wherein the common data signal is indicative of the detected objects on the touch screen.

2. The method of claim 1 wherein in the serializing step, the data signals further comprise a tune data signal for tuning receivers of the touch screen.

3. The method of claim 2 wherein the tune data signal is transmitted to a plurality of tuning circuits of the receivers to adjust the sensitivity level of the receivers.

4. The method of claim 3 wherein in the deserializing step, one or more serial-parallel shift (“SPS”) registers are used for deserializing the tune data signal to generate parallel outputs to simultaneously operate the tuning circuits.

5. The method of claim 3 wherein each of the tuning circuits has multiple resistors to adjust the pull down resistance of the corresponding one of the receivers, wherein one or more of the multiple resistors are enabled according to the tune data signal.

6. The method of claim 1 in the deserializing step, one or more serial-parallel shift (“SPS”) registers are used for deserializing the group data signal to generate parallel outputs to simultaneously operate the transmitters and the receivers.

7. The method of claim 1 wherein the transmitters and the receivers form transmitter and receiver pairs, and wherein the transmitter and receiver pairs are activated according to a group scanning scheme.

8. The method of claim 1 in the serializing step, one or more parallel-serial shift (“PSS”) registers are used for serializing the common data signal to generate a serial output.

9. The method of claim 1 in the serializing step, wherein the serialized data signals comprise the common data signal, the group data signal, and the tune data signal, and in the transmitting step, a single GPIO pin is used in transmitting the serialized data signals.

10. The method of claim 9 wherein the common data signal, the group data signal, and the tune data signal are transmitted at different times via the single GPIO pin.

11. A method for detecting one or more objects on a touch screen, wherein said touch screen has a plurality of transmitters and receivers, comprising the steps:
serializing data signals into a group data signal corresponding to the transmitters and the receivers of the touch screen;
transmitting and deserializing the group data signal to the transmitters and the receivers, wherein one or more serial-parallel shift (“SPS”) registers are used for deserializing the group data signal to generate parallel outputs to simultaneously operate the transmitters and the receivers;
receiving receiver data indicative of the detection of one or more objects on the touch screen;
serializing the receiver data into serialized common data signal, wherein one or more parallel-serial shift (“PSS”) registers are used for serializing the common data signal to generate a serial output; and
outputting the common data signal, wherein the common data signal is indicative of the detected objects on the touch screen.

12. The method of claim 11 wherein in the serializing step, the data signals further comprise a tune data signal for tuning receivers of the touch screen.

13. The method of claim 12 wherein the tune data signal is transmitted to a plurality of tuning circuits of the receivers to adjust the sensitivity level of the receivers.

14. The method of claim 13 wherein in the deserializing step, one or more serial-parallel shift (“SPS”) registers are used for deserializing the tune data signal to generate parallel outputs to simultaneously operate the tuning circuits.

15. The method of claim 13 wherein each of the tuning circuits has multiple resistors to adjust the pull down resistance of the corresponding one of the receivers, wherein one or more of the multiple resistors are enabled according to the tune data signal.

16. The method of claim 11 wherein the transmitters and the receivers form transmitter and receiver pairs, and wherein the transmitter and receiver pairs are activated according to a group scanning scheme.

17. The method of claim 11 in the serializing step, wherein the serialized data signals comprise the common data signal, the group data signal, and the tune data signal, and in the transmitting step, a single GPIO pin is used in transmitting the serialized data signals.

18. The method of claim 17 wherein the common data signal, the group data signal, and the tune data signal are transmitted at different times via the single GPIO pin.

19. A method for detecting one or more objects on a touch screen, wherein said touch screen has a plurality of transmitters and receivers, comprising the steps:
serializing data signals into a group data signal corresponding to the transmitters and the receivers of the touch screen and into a tune data signal for tuning receivers of the touch screen;
transmitting and deserializing the group data signal to the transmitters and the receivers and the tune data signal to a plurality of tuning circuits of the receivers to adjust the sensitivity level of the receivers, wherein one or more serial-parallel shift (“SPS”) registers are used for deserializing the tune data signal to generate parallel outputs to simultaneously operate the tuning circuits, wherein each of the tuning circuits has multiple resistors to adjust the pull down resistance of the corresponding one of the receivers, wherein one or more of the multiple resistors are enabled according to the tune data signal, and wherein one or more serial-parallel shift (“SPS”) registers are used for deserializing the group data signal to generate parallel outputs to simultaneously operate the transmitters and the receivers;
receiving receiver data indicative of the detection of one or more objects on the touch screen;
serializing the receiver data into serialized common data signal, wherein one or more parallel-serial shift (“PSS”) registers are used for serializing the common data signal to generate a serial output; and
outputting the common data signal, wherein the common data signal is indicative of the detected objects on the touch screen.

20. The method of claim 19 in the serializing step, wherein the serialized data signals comprise the common data signal, the group data signal, and the tune data signal, and in the transmitting step, a single GPIO pin is used in transmitting the serialized data signals and wherein the common data signal, the group data signal, and the tune data signal are transmitted at different times via the single GPIO pin.
